(19) United States
(12) Patent Application Publication
(10) Pub. No.: US 2022/0400684 A1
(43) Pub. Date: Dec. 22, 2022

(54) BACILLUS THURINGIENSIS PESTICIDE FORMULATIONS

(71) Applicants: Dow Global Technologies LLC, Midland, MI (US); Rohm and Haas Company, Collegeville, PA (US)

(72) Inventors: Selvanathan Arumugam, West Chester, PA (US); Caroline Woelfle-Gupta, Midland, MI (US); Wanglin Yu, Pearland, TX (US)

(73) Assignees: Dow Global Technologies LLC, Midland, MI (US); Rohm and Haas Company, Collegeville, PA (US)

(21) Appl. No.: 17/779,169

(22) PCT Filed: Jan. 28, 2021
(86) PCT No.: PCT/US2021/015479

§ 371 Date: May 24, 2022

Related U.S. Application Data
(60) Provisional application No. 62/970,431, filed on Feb. 5, 2020.

(51) Int. Cl. A01N 63/23

(52) U.S. Cl. CPC A01N 63/23

(57) ABSTRACT

A pesticide formulation of the present invention includes Bacillus thuringiensis, a polyethylene glycol having a weight average molecular weight of from 1,000 g/mol to 12,000 g/mol as measured according to gel permeation chromatography, and a polyphenol.

### BACKGROUND

### Field of the Invention

The present disclosure generally relates to pesticide formulations, and more specifically, to pesticide formulations comprising Bacillus thuringiensis.

### Introduction

Pesticide formulations used in crop defense applications are traditionally sprayed on the tissues of the crops as part of a crop defense formulation. Traditional pesticide formulations may include pesticides perceived to be toxic to humans and may remain on the crops after harvesting and be transferred to the end consumer of such crops. Further, water in the form of rain and irrigation may wash the traditional pesticides off the crop tissues thereby contaminating water ways while also leaving the crops unprotected from pests.

A conventional replacement for traditional pesticides includes bio-based pesticides that use naturally occurring microbes and bacteria to deter and kill pests. One bacteria that has been used in bio-based pesticides is Bacillus thuringiensis. Bacillus thuringiensis is applied to crops in the form of spores and crystalized proteins in a pesticide formulation. During the sporulation process of Bacillus thuringiensis, the Bacillus thuringiensis produces the crystalized proteins that are toxic to certain pests. When an insect ingests crop tissue with the Bacillus thuringiensis spores and proteins, the protein opens pores within the insect's digestive tract. The Bacillus thuringiensis spores then pass through the pores, become active and multiply within the insect's blood stream. The rapid bacterial growth within the insect's blood stream results in septicemia and death of the insect.

Bacillus thuringiensis suffers from a number of disadvantages when used in crop defense settings because of its mechanisms of operation. For example, CA2184019A1 details that when Bacillus thuringiensis is exposed to ultraviolet radiation the effect can be inactivation of the crystallized proteins and damage to the DNA of the spores. CN103160449A discloses the use of humic acid to protect Bacillus thuringiensis from ultraviolet radiation. Further, the proteins and spores are susceptible to being removed from the crop tissue by water in the form of rain and irrigation. As the Bacillus thuringiensis relies on both the proteins and the viability of the spores for maximum effectiveness, the environment of crop defense applications is challenging for Bacillus thuringiensis.

Pesticide formulations typically include humectants (e.g., polyethylene glycol), spreaders and stickers, rheology modifiers, nutrients as well as multiple other adjuvants leading to complicated formulations. Interactions and side reactions often occur between different adjuvants present in a pesticide formulation that can decrease efficacy of one or more properties of the pesticide formulation. The use of pesticides such as Bacillus thuringiensis typically requires the addition of yet more adjuvants, with potential side reactions, to address known challenges in using the pesticide.

The interaction of phenols and non-ionic polymers in formulations has been studied in the pharmaceutical sciences for decades. For example, Interaction of Nonionic Hydrophobic Polymers with Phenols I by B. N. Kabadi examines the interaction of phenols and polyethylene glycol. Kabadi explains that phenols preferentially interfere with the stabilizing and solubilizing properties of polyethylene glycol by forming hydrogen bonds between the OH groups of the phenols and the ether bridges of the polyethylene glycol. The hydrogen bonding tends to result in the formation of hydrophobic macromolecular structures that clump and segregate the phenol and the polyethylene glycol together. As a result, the individual properties each of the polyethylene glycol and phenol imparted to the formulation are decreased or eliminated.

Accordingly, it would be surprising to discover a pesticide formulation that includes both a polyphenol and polyethylene glycol while also addressing one or more of the traditional drawbacks of Bacillus thuringiensis.

### BRIEF SUMMARY OF THE INVENTION

The present invention offers a solution to providing pesticide formulations that include both a polyphenol and polyethylene glycol while also addressing one or more of the traditional drawbacks of Bacillus thuringiensis.

The present invention is a result of discovering that despite the preferential interaction of polyethylene glycol and phenol demonstrated in the prior art, formulations comprising both polyethylene glycol and polyphenol can address the traditional difficulties of using Bacillus thuringiensis in crop defense applications. This discovery is surprising because the preferential interaction of polyethylene glycol and polyphenol would be expected to cause aggregation of these components resulting in each of these components having decreased or no impact on the Bacillus thuringiensis. Surprisingly it has been discovered that Bacillus thuringiensis viability of a combined polyethylene glycol, polyphenol and Bacillus thuringiensis formulation after exposure to rain is approximately the summation of each independent component. Such a result is unexpected because one would predict aggregation of the polyethylene glycol and polyphenol to result in a Bacillus thuringiensis viability less than the summation of the individual components.

Additionally, it has been discovered that a Bacillus thuringiensis viability of greater than 90% after exposure to ultraviolet light using simulated sunlight can be achieved using a combined polyethylene glycol, polyphenol and Bacillus thuringiensis formulation. Similarly to the rainfastness, the expected decrease in Bacillus thuringiensis viability due to the aggregation of the polyphenol unexpectedly does not manifest itself.

The polyethylene glycol, polyphenol and Bacillus thuringiensis formulation of the present invention is particularly useful as a pesticide formulation.

According to at least one feature of the present disclosure, a pesticide formulation includes Bacillus thuringiensis, a polyethylene glycol having a weight average molecular weight of from 1,000 g/mol to 12,000 g/mol as measured according to gel permeation chromatography, and a polyphenol.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated. Subscript values in polymer formulae refer to mole average values for the designated component in the polymer.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, the term “average molecular weight” is the number average molecular weight and is tested using a hydroxyl number analysis as described by ASTM standard D4274.

As used herein, a “wt %” or “weight percent” or “percent by weight” of a component, unless specifically stated to the contrary, is based on the total weight of the composition or article in which the component is included. As used herein, all percentages are by weight unless indicated otherwise.

Pesticide Formulation The present invention comprises a pesticide formulation that comprises Bacillus thuringiensis, a polyethylene glycol, and a polyphenol. According to various embodiments, the pesticide formulation consists of water, Bacillus thuringiensis, a polyethylene glycol, and a polyphenol. The pesticide formulation may be utilized in a crop defense formulation where the pesticide formulation is 50 wt % or less of the crop defense formulation.

### Polyethylene Glycol

The pesticide formulation comprises polyethylene glycol. Polyethylene glycol refers to an oligomer or polymer of ethylene oxide represented by the formula H—(O—CH₂—CH₂)_{q}—OH, where q refers to the number of repeat units in the polyethylene glycol polymer. The q value for the polyethylene glycol may be in a range from 20 to 250.

The weight average molecular weight of the polyethylene glycol may be 1,000 g/mol or more, or 2,000 g/mol or more, or 3,000 g/mol or more, or 3,500 g/mol or more, or 4,000 g/mol or more, or 4,500 g/mol or more, or 5,000 g/mol or more, or 5,500 g/mol or more, or 6,000 g/mol or more, or 6,500 g/mol or more, or 7,000 g/mol or more, or 7,500 g/mol or more, or 8,000 g/mol or more, or 8,500 g/mol or more, or 9,000 g/mol or more, or 9,500 g/mol or more, or 10,000 g/mol or more, or 10,500 g/mol or more, or 11,000 g/mol or more, while at the same time, 12,000 g/mol or less, or 10,500 g/mol or less, or 10,000 g/mol or less, or 9,500 g/mol or less, or 9,000 g/mol or less, or 8,500 g/mol or less, or 8,000 g/mol or less, or 7,500 g/mol or less, or 7,000 g/mol or less, or 6,500 g/mol or less, or 6,000 g/mol or less, or 5,500 g/mol or less, or 5,000 g/mol or less, or 4,500 g/mol or less, or 4,000 g/mol or less, or 3,500 g/mol or less, or 3,000 g/mol or less, or 2,000 g/mol or less as measured by gel permeation chromatography. For example, the weight average molecular weight of the polyethylene glycol may be from 3,000 g/mol to 9,000 g/mol, or from 4,000 g/mol to 8,000 g/mol, or from 5,000 g/mol to 7,000 g/mol, or 6,000 g/mol. A blend of different average molecular weight polyethylene glycols, at the same or different weight percent, may be utilized in the pesticide formulation.

The polyethylene glycol may be from 0.2 wt % to 10 wt % of the pesticide formulation. The pesticide formulation may comprise the polyethylene glycol at 0.2 wt % or more, or 0.5 wt % or more, or 1.0 wt % or more, or 1.5 wt % or more, or 2.0 wt % or more, or 2.5 wt % or more, or 3.0 wt % or more, or 3.5 wt % or more, or 4.0 wt % or more, or 4.5 wt % or more, or 5.0 wt % or more, or 5.5 wt % or more, or 6.0 wt % or more, or 6.5 wt % or more, or 7.0 wt % or more, or 7.5 wt % or more, or 8.0 wt % or more, or 8.5 wt % or more, or 9.0 wt % or more, or 9.5 wt % or more, while at the same time, 10 wt % or less, or 9.5 wt % or less, or 9.0 wt % or less, or 8.5 wt % or less, or 8.0 wt % or less, or 7.5 wt % or less, or 7.0 wt % or less, or 6.5 wt % or less, or 6.0 wt % or less, or 5.5 wt % or less, or 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less.

### Bacillus Thuringiensis

The pesticide formulation comprises Bacillus thuringiensis. As defined herein, “Bacillus thuringiensis” is defined as the spores and/or the crystallized proteins of the species Bacillus thuringiensis and includes all Bacillus thuringiensis subspecies exhibiting insecticidal properties. Examples of such subspecies include kurstaki, israelensis and aizawa. The Bacillus thuringiensis may be added to the pesticide formulation as either a solid or as part of a liquid formulation. The presence and subspecies of Bacillus thuringiensis is determined by Random Amplified Polymorphic DNA analysis. A commercially available liquid formulation of Bacillus thuringiensis is THURICIDE™ pesticide available from CERTIS USA, Columbia, Md.

Polyphenol The pesticide formulation comprises one or more polyphenols. As used herein, the term “polyphenol” is defined to mean a liquid consisting of one or more of humic acid, fulvic acid, and tannic acid. Humic acid, fulvic acid, and tannic acid each comprise multiple phenol functional groups thereby rendering each a polyphenol. Humic acid is an acidic organic polymer that can be extracted from humus found in soil, sediment, or aquatic environments. Humic acid is identified by the Chemical Abstracts Service (CAS) number 1415-93-6 and has the average chemical formula C₁₈₇H₁₈₆O₈₉N₉S₁. Fulvic acid is an organic acid having a CAS number of 479-66-3 and a chemical formula of C₁₄H₁₂O₈. Tannic acid is an organic acid having a CAS number of 1401-55-4 and a chemical formula of C₇₆H₅₂O₄₆. Blends of humic acid and fulvic acid are commercially available as FLORIS™ soil nutrient from ORGANOCAT, Louisville, Ky. Tannic acid is commercially available from SIGMA ALDRICH. The presence of the polyphenol within the pesticide formulation is determined by High Performance Liquid Chromatography. The formulation may comprise polyphenol at a concentration of 0.2 wt % or more, or 0.5 wt % or more, or 1.0 wt % or more, or 1.5 wt % or more, or 2.0 wt % or more, or 2.5 wt % or more, or 3.0 wt % or more, or 3.5 wt % or more, or 4.0 wt % or more, or 4.5 wt % or more, while at the same time, 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less. The wt % of the polyphenol within the pesticide formulation is determined based on the amount and polyphenol concentration of a polyphenol comprising material added to the pesticide formulation. The polyphenol may comprise humic acid, fulvic acid or tannic acid singly or in any combination to reach the above-noted polyphenol concentration within the pesticide formulation.

The polyphenol may have a fulvic acid to humic acid weight ratio of from 2:100 or greater, or 4:100 or greater, or 6:100 or greater, or 8:100 or greater, or 10:100 or greater, 12:100 or greater, or 14:100 or greater, or 16:100 or greater, or 18:100 or greater, while at the same time, 20:100 or less, or 18:100 or less, or 16:100 or less, or 14:100 or less, or 12:100 or less, or 10:100 or less, or 8:100 or less, or 6:100 or less, or 4:100 or less, or 2:100 or less.

### Adjuvants

The pesticide formulation may comprise one or additives or adjuvants. Examples of additives include viscosity modifiers, pH modifiers, herbicides, fungicides, and combinations thereof, among others without departing from the teachings provided herein.

### Crop Defense Formulation

The pesticide formulation may be utilized within a crop defense formulation. The crop defense formulation may comprise the pesticide formulation at a concentration of 1 wt % or greater, or 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, while at the same time, 50 wt % or less, or 45 wt % or less, or 40 wt % or less, or 35 wt % or less, or 30 wt % or less, or 25 wt % or less, or 20 wt % or less, or 15 wt % or less, or 10 wt % or less. The individual components of the pesticide formulation may be separately added to the crop defense formulation without departing from the teachings provided herein.

### EXAMPLES

### Materials

The Bacillus thuringiensis formulation for use in the following samples is a liquid insecticide containing 98.35 wt % of a kurstaki subspecies Bacillus thuringiensis solution (“BT Solution”) commercially available as THURICIDE™ HPC—O biological insecticide from CERTIS USA, Columbia, Md.

The polyphenol for use in the following samples is a blend of 5.2 wt % humic acid, 0.5 wt % fulvic acid and balance water, an example of which is commercially available as FLORIS™ soil nutrient from ORGANOCAT, Louisville, Ky.

The PEG for use in the following samples is polyethylene glycol having a weight average molecular weight of 6000 g/mol, commercially available from SIGMA ALDRICH.

Sample Preparation Prepare comparative examples (“CE”) CE1-CE3 and inventive examples (“IE”) IE1-IE6 according to the following procedure.

Prepare CE1 by sampling the Bacillus thuringiensis formulation neat.

Prepare CE2 by combining 2 grams of Bacillus thuringiensis formulation and 5 wt % of PEG based on the weight of CE2 and mixing with a magnetic stir bar.

Prepare CE3 by combining 2 grams Bacillus thuringiensis formulation and 5 wt % of Polyphenol based on the weight of CE3 and mixing with a magnetic stir bar.

Prepare IE1 by making a preliminary formulation containing 2.5 wt % of PEG, 2.5 wt % of Polyphenol and balance water based on the weight of the preliminary formulation. Combine the preliminary formulation (1 mL), Bacillus thuringiensis formulation (2 grams), and water (17 grams) and mix with a magnetic stir bar to provide IE1.

Prepare 1E2 by making a preliminary formulation containing 5 wt % of PEG, 5 wt % of Polyphenol and balance water based on the weight of the preliminary formulation. Combine the preliminary formulation (1 mL), Bacillus thuringiensis formulation (2 grams), and water (17 grams) and mix with a magnetic stir bar to provide IE 2.

Prepare IE3 by making a preliminary formulation containing 1.5 wt % of PEG and 3.5 wt % of Polyphenol and balance water based on the weight of the preliminary formulation. Combine the preliminary formulation (1 mL), Bacillus thuringiensis formulation (2 grams), and water (17 grams) and mix with a magnetic stir bar to provide IE3.

Prepare 1E4 by making a preliminary formulation containing 3.5 wt % of PEG and 1.5 wt % of Polyphenol and balance water based on the weight of the preliminary formulation. Combine the preliminary formulation (1 mL), Bacillus thuringiensis formulation (2 grams), and water (17 grams) and mix with a magnetic stir bar to provide 1E4.

Prepare 1E5 by making a preliminary formulation containing 7.0 wt % of PEG and 3.0 wt % of Polyphenol and balance water based on the weight of the preliminary formulation. Combine the preliminary formulation (1 mL), Bacillus thuringiensis formulation (2 grams), and water (17 grams) and mix with a magnetic stir bar to provide IE5.

Prepare 1E6 by making a preliminary formulation containing 10.5 wt % of PEG and 4.5 wt % of Polyphenol and balance water based on the weight of the preliminary formulation. Combine the preliminary formulation (1 mL), Bacillus thuringiensis formulation (2 grams), and water (17 grams) and mix with a magnetic stir bar to provide 1E6.

Table 1 provides a summary of the weight percent of the various components of the comparative and inventive examples based on the materials used and the sample preparation methods.

TABLE 1

| | BT | | Humic | Fulvic | | |
|---|---|---|---|---|---|---|
| | Solution | PEG | Acid | Acid | Polyphenol | Water |
| CE1 | 98.35 | 0.00 | 0.00 | 0.00 | 0.00 | 0.00 |
| CE2 | 79.33 | 2.02 | 0.00 | 0.00 | 0.00 | 17.20 |
| CE3 | 79.21 | 0.00 | 2.02 | 0.24 | 2.26 | 17.20 |
| IE1 | 79.33 | 1.01 | 1.01 | 0.12 | 1.13 | 17.20 |
| IE2 | 66.47 | 1.69 | 1.69 | 0.20 | 1.89 | 28.83 |
| IE3 | 74.25 | 0.47 | 1.32 | 0.16 | 1.48 | 22.55 |
| IE4 | 85.24 | 1.52 | 0.65 | 0.08 | 0.73 | 11.09 |
| IE5 | 75.21 | 2.68 | 1.15 | 0.14 | 1.29 | 19.57 |
| IE6 | 74.21 | 3.96 | 1.7 | 0.2 | 1.9 | 18.68 |

### Test Methods

### Rainfastness Testing

Perform rainfastness testing by cutting 5.08 centimeters (“cm”) by 10.16 cm swatches of PARAFILM M™ (from BEMIS COMPANY) laboratory film and placing the swatches on a black colored LENETA™ chart (from LENETA COMPANY). Wipe the swatches of PARAFILM M™ laboratory film with a KIMWIPE™ wiper (from KIMBERLY CLARK). Dilute CE1-CE3 and IE1-IE6 to 71 g of each sample per liter of water before using for rainfastness testing. Randomly place 15 drops (15-30 microliters) of the diluted CE1-CE3 and the diluted IE1-IE6 using an auto-pipettor in an array on the respective swatches, one swatch for each IE and CE. Vortex mix the diluted IE and the diluted CE between each set of 5 drops to maintain composition consistency. Dry the swatches with the diluted IE1-IE6 and the diluted CE1-CE3 in an incubator at approximately 28° C. for approximately 1 hour.

Subject each of the dried swatches to simulated rain using an EXO TERRA MONSOON RS400 RAINFALL SYSTEM™ fitted with 2 EXO TERRA™ standard nozzles without any extensions. Place the swatches 33 cm away from the spray nozzle. Spray water at the swatches at a flow rate of 1.5 liters/hour, measured at the swatch interface for 5 minutes. Allow the swatches to air dry.

Extract samples by cutting each swatch such that each of the 15 dried drops representing one IE or CE per swatch is centered on an approximately 0.63 cm square. Place the fifteen 0.63 cm squares obtained per swatch into a glass vial. Add a sodium dodecyl sulfate solution (1 milliliter, 2 wt % sodium dodecyl sulfate in water) to each vial. Sonicate each vial three times and allow to soak for 8 hours.

Determine residual protein concentrations through bicinchoninic acid assay (BCA) as follows. PIERCE™ BCA Protein Assay Reagent A and PIERCE™ BCA Protein Assay Reagent B (both obtained from THERMO SCIENTIFIC) were combined Reagent A (2 milliliters) and Reagent B (40 microliters) to form a reagent mixture. One hundred (100) microliters of each extracted sample was placed into a respective cuvette; then the reagent mixture (2 milliliters) was added to each cuvette; and then the cuvettes were incubated at 30° C. for approximately 2 hours. Absorption values at 562 nm measured with a CARY 100™ UV-Visible Spectrophotometer from AGILENT were used to determine the residual protein concentrations.

Determine spore viability by extracting samples from the swatches using a 1 wt % solution of TWEEN™ 20 polysorbate nonionic surfactant. Plate the extracted CE1 and IE 1 by diluting the samples using a 0.1 wt % solution of TWEEN™ 20 polysorbate nonionic surfactant then serially diluting at suitable concentrations. Plate the extracted and diluted CE1 and IE1 samples evenly in 10 μL drops on agar sample growth plates. Hold the plates in an incubator at 30° C. for 12 hours. Count the number of colonies expressed as log colony forming units/mL, while accounting for dilution factors.

### Ultraviolet Light(“UV”) Testing

Bacillus thuringiensis activities before and after exposure to light for CE1 and IE1 are determined as follows.

Use an auto-pipettor to place 30 μL drops of CE1 and IE1 on separate plastic petri dishes and dry for approximately 1 hour. Expose CE1 and IE1 to light at 35 milliwatts/cm² for 2 hours using a SUMMER GLOW™ HB175 lamp from HAPRO that simulates natural sunlight. Extract CE1 and IE1 from the petri dishes using a 1 wt % solution of TWEEN™ 20 polysorbate nonionic surfactant. Plate the extracted CE1 and IE1 by diluting the samples using a 0.1 wt % solution of TWEEN™ 20 polysorbate nonionic surfactant then then serially diluting at suitable concentrations. Plate the extracted and diluted CE1 and IE1 samples evenly in 10 μL drops in agar sample growth plates. Hold the plates in an incubator at 30° C. for 12 hours. Count the number of colonies expressed as log colony forming units/mL, while accounting for dilution factors.

### Results

Table 2 provides the protein retention of CE1-CE3 and IE1-IE6 for a given exposure time to the simulated rain conditions.

TABLE 2

| | Exposure Time (min) | Protein Retention (%) |
|---|---|---|
| CE1 | 5 | 0.00 |
| CE1 | 10 | 0.00 |
| CE2 | 5 | 61.00 |
| CE3 | 5 | 33.00 |
| IE1 | 5 | 73.80 |
| IE1 | 10 | 65.25 |
| IE2 | 5 | 88.89 |
| IE2 | 10 | 64.89 |
| IE3 | 5 | 93.20 |
| IE3 | 10 | 88.14 |
| IE4 | 5 | 80.79 |
| IE4 | 10 | 56.34 |
| IE5 | 5 | 85.08 |
| IE5 | 10 | 54.43 |
| IE6 | 5 | 92.53 |
| IE6 | 10 | 62.53 |

As shown by the results, CE1 representing just the application of Bacillus thuringiensis to crops exhibits 0 retained proteins, regardless of exposure time, demonstrates that the crystal proteins of Bacillus thuringiensis have little to no rainfastness. CE2 and CE3 demonstrate that the addition of a polyethylene glycol and a polyphenol alone to a Bacillus thuringiensis formulation increases the rainfastness of the crystal proteins. As explained above, traditional understanding of phenol and non-ionic polymer systems suggests that the phenols and non-ionic polymers would aggregate through hydrogen bonding causing both components to become less dispersed throughout the system. It would be expected that the rainfastness would correspondingly be less than the cumulative addition of the two components owing to the expected clumping and segregation. As surprisingly discovered, the rainfastness of IE1-IE6 demonstrates a cumulative property of both the polyphenol and the polyethylene glycol. Accordingly, IE1-IE6 demonstrate that a formulation of Bacillus thuringiensis, a polyethylene glycol and polyphenol can exhibit effective rainfastness by retaining a greater percentage of crystal proteins than any of CE1-CE3.

Table 3 provides the viability of spores of the Bacillus thuringiensis after a period of time exposed to the simulated rain conditions.

TABLE 3

| | | Bt Activity | Bt Activity | |
|---|---|---|---|---|
| | Exposure | (log CFU/mL) - | (log CFU/mL) - | % |
| | (min) | Pre-spray | Post-spray | Viability |
| CE1 | 5 | 8.53 ± 0.13 | 5.78 ± 0.10 | 68 |
| IE1 | 5 | 8.28 ± 0.11 | 8.04 ± 0.13 | 97 |

As shown by the results, CE1 representing just the application of Bacillus thuringiensis to crops exhibits 68% viability of Bacillus thuringiensis spores after rainfastness testing. IE1 demonstrates that the addition of both polyethylene glycol and polyphenol to Bacillus thuringiensis surprisingly increases the viability of Bacillus thuringiensis spores after exposure to water. This result is indicative that not only is the combined polyphenol and polyethylene glycol system effective at increasing the rainfastness of the crystalline proteins, but it also is effective at maintaining the viability of the spores of the Bacillus thuringiensis.

Table 4 provides the viability of spores of the Bacillus thuringiensis after a period of time exposed to the simulated light conditions.

TABLE 4

| | Bt Activity (log | Bt Activity (log | % |
|---|---|---|---|
| | CFU/mL) - Dark | CFU/mL) - Exposure | viability |
| CE1 | 8.53 ± 0.13 | 5.78 ± 0.10 | 0 |
| IE1 | 8.28 ± 0.11 | 8.04 ± 0.13 | 94 |

As shown by the results, CE1 representing just the application of Bacillus thuringiensis to crops exhibits 0% spore viability after exposure to simulated sun light. As explained above, traditional understanding of phenol and non-ionic polymer systems suggests that the phenols and non-ionic polymers would aggregate through hydrogen bonding causing both components to become less dispersed throughout the system. It would be expected that the ultraviolet protection offered by the polyphenol would be minimized or eliminated due to clumping and segregation with the polyethylene glycol. As surprisingly discovered, viability of IE1-IE6 demonstrates that the polyphenol is still actively protecting the Bacillus thuringiensis. Accordingly, IE1-IE6 demonstrate that a formulation of Bacillus thuringiensis, a polyethylene glycol and can exhibit effective ultraviolet protection.

1. A pesticide formulation, comprising:
Bacillus thuringiensis;
a polyethylene glycol wherein the polyethylene glycol has a weight average molecular weight of from 1,000 g/mol to 12,000 g/mol as measured according to gel permeation chromatography; and
a polyphenol.

2. The pesticide formulation of claim 1, wherein the polyethylene glycol has a weight average molecular weight of from 5,000 g/mol to 7,000 g/mol as measured according to gel permeation chromatography.

3. The pesticide formulation of claim 2, wherein the polyethylene glycol has a weight average molecular weight of 6,000 g/mol as measured according to gel permeation chromatography.

4. The pesticide formulation of claim 1, wherein the pesticide formulation comprises from 0.2 wt % to 10 wt % polyethylene glycol based on a total weight of the pesticide formulation.

5. The pesticide formulation of claim 4, wherein the pesticide formulation comprises from 0.2 wt % to 5 wt % of polyethylene glycol based on a total weight of the pesticide formulation.

6. The pesticide formulation of claim 1, wherein the Bacillus thuringiensis comprises kurstaki subspecies Bacillus thuringiensis.

7. The pesticide formulation of claim 1, wherein the polyphenol comprises fulvic acid.

8. (canceled)

9. (canceled)

10. The pesticide formulation of claim 1, wherein the polyphenol comprises fulvic acid and humic acid, further at wt % ratio between fulvic acid and humic acid is from 2:100 to 20:100.

11. The pesticide formulation of claim 8, wherein the wt % ratio between fulvic acid and humic acid is from 8:100 to 14:100.
